(19) United States
(12) Patent Application Publication
(10) Pub. No.: US 2008/0140264 A1
(43) Pub. Date: Jun. 12, 2008

(54) Method for providing stability control for a vehicle

(76) Inventors: Kevin A. O'Dea, Ann Arbor, MI (US); Michael J. Check, Ann Arbor, MI (US)

Correspondence Address: DELPHI TECHNOLOGIES, INC., M/C 480-410-202, PO BOX 5052, TROY, MI, 48007, US

(21) Appl. No.: 11/636,002

(22) Filed: Dec. 8, 2006

(51) Int. Cl. G06F 17/00

(52) U.S. Cl. 701/1; 701/70

(57) ABSTRACT

A method provides stability control for a vehicle and includes: calculating a modified desired yaw rate for the vehicle using steer angle, steer angle rate, steer transition state, steer transition time, vehicle speed, lateral acceleration, and estimated surface friction; calculating a modified desired speed difference between the left and right wheels using the modified desired yaw rate, the steer angle rate, roll angle rate, the estimated surface friction, the vehicle speed, and sensed yaw rate; and applying the modified desired speed difference to the left and right wheels. Another method calculates an initial desired speed difference between the left and right wheels using the modified desired yaw rate, the estimated surface friction, the vehicle speed, and sensed yaw rate. Another method calculates a filtered initial desired yaw rate for the vehicle using steer angle, vehicle speed, and lateral acceleration.

### TECHNICAL FIELD

The present invention relates generally to vehicle control systems, and more particularly to a method for providing stability control for a vehicle.

### BACKGROUND OF THE INVENTION

Conventional vehicle electronic control systems: calculate a desired yaw rate using steer angle, lateral acceleration and vehicle speed; filter the desired yaw rate using a first order filter having a tau damping value based on vehicle speed; calculate a desired speed difference between the left and right wheels using the filtered desired yaw rate, sensed yaw rate, estimated surface friction and vehicle speed; and apply the desired speed difference to the left and right wheels (by individualized four-wheel braking).

What is needed is an improved method for providing stability control for a vehicle having left and right wheels.

### SUMMARY OF THE INVENTION

A first method of the invention is for providing stability control for a vehicle having left and right wheels and includes calculating a modified desired yaw rate for the vehicle using steer angle, steer angle rate, steer transition state, steer transition time, vehicle speed, lateral acceleration, and estimated surface friction. The first method also includes calculating a modified desired speed difference between the left and right wheels using the modified desired yaw rate, the steer angle rate, roll angle rate, the estimated surface friction, the vehicle speed, and sensed yaw rate. The first method also includes applying the modified desired speed difference to the left and right wheels.

A second method of the invention is for providing stability control for a vehicle having left and right wheels. The second method includes calculating a modified desired yaw rate for the vehicle using steer angle, steer angle rate, steer transition state, steer transition time, vehicle speed, lateral acceleration, and estimated surface friction. The second method also includes calculating an initial desired speed difference between the left and right wheels using the modified desired yaw rate, the estimated surface friction, the vehicle speed, and sensed yaw rate. The second method also includes applying the initial desired speed difference to the left and right wheels.

A third method of the invention is for providing stability control for a vehicle having left and right wheels. The third method includes calculating a filtered initial desired yaw rate for the vehicle using steer angle, vehicle speed, and lateral acceleration. The third method also includes calculating a modified desired speed difference between the left and right wheels using the filtered initial desired yaw rate, the steer angle rate, roll angle rate, the estimated surface friction, the vehicle speed, and sensed yaw rate. The third method also includes applying the modified desired speed difference to the left and right wheels.

Several benefits and advantages are derived from one or more of the methods of the invention. In one example, after certain steering reversals by the driver with high steering angle rates, the initial desired yaw rate is limited for some time after the event to reduce the yaw rate overshoot. In the same or a different example, during certain maneuvers involving high steer angle rates, damping of the desired yaw rate is increased to slow the response of the vehicle control to inputs from the driver for increased vehicle stability. In the same or a different example, during certain maneuvers involving high roll angle rates and high steer angle rates, the vehicle control term (i.e., the desired speed difference) is offset by a function of the roll angle rate and the vehicle speed and is offset by a function of the steer angle rate and the vehicle speed for increased vehicle stability.

### SUMMARY OF THE DRAWINGS

FIG. 1 is a flow chart of one example of a first method of the invention for providing stability control for a vehicle which calculates a modified desired yaw rate, which calculates a modified desired speed difference between the left and right wheels of the vehicle, and which applies the modified desired speed difference to the left and right wheels;

FIG. 2 is a block diagram showing a vehicle reference model having various inputs and having the modified desired yaw rate mentioned in FIG. 1 as an output and showing a vehicle control term calculator (modified desired speed difference calculator) having various inputs including the modified desired yaw rate and having the modified desired speed difference mentioned in FIG. 1 as an output;

FIG. 3 is a block diagram showing details of the vehicle reference model of FIG. 2 including an initial desired yaw rate calculator (labeled conventional calculations in FIG. 2), a yaw rate limit calculator, a tau damping value calculator, and a first order filter having the calculated tau damping value;

FIG. 4 is a block diagram showing details of the yaw rate limit calculator of FIG. 3;

FIG. 5 is a block diagram showing details of the tau damping value calculator of FIG. 3;

FIG. 6 is a block diagram showing details of the vehicle control term calculator of FIG. 2 including the calculation of an initial desired speed difference;

FIG. 7 is a flow chart of one example of a second method of the invention which calculates a modified desired yaw rate, which calculates an initial desired speed difference between the left and right wheels of the vehicle, and which applies the initial desired speed difference to the left and right wheels; and

FIG. 8 is a flow chart of one example of a third method of the invention which calculates a filtered initial desired yaw rate, which calculates a modified desired speed difference between the left and right wheels of the vehicle, and which applies the modified desired speed difference to the left and right wheels.

### DETAILED DESCRIPTION

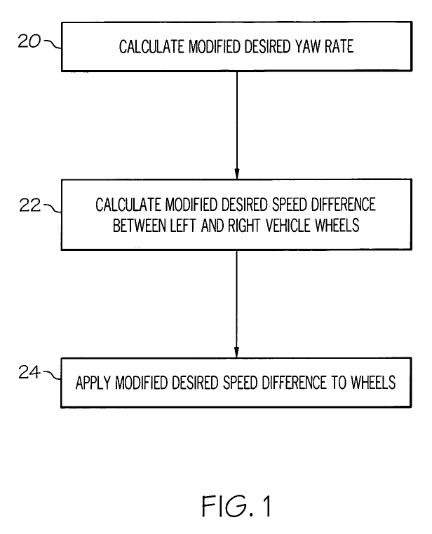

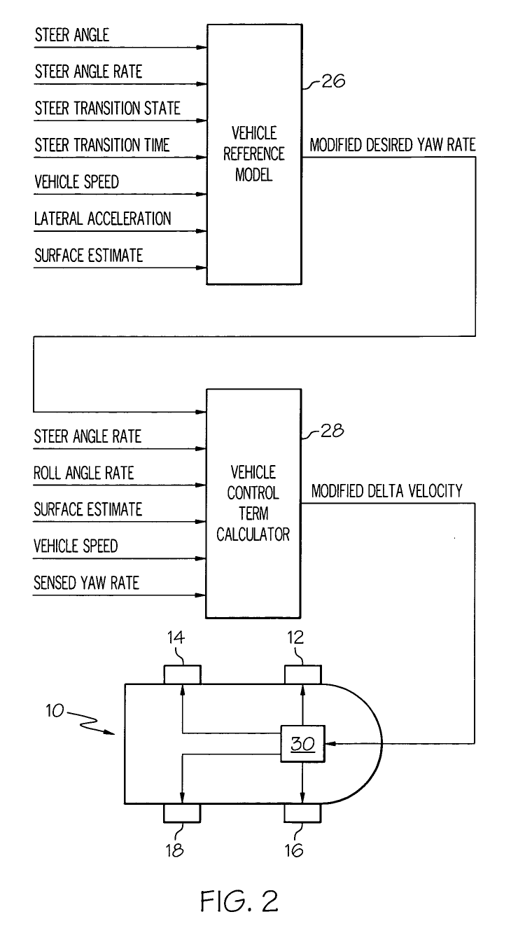

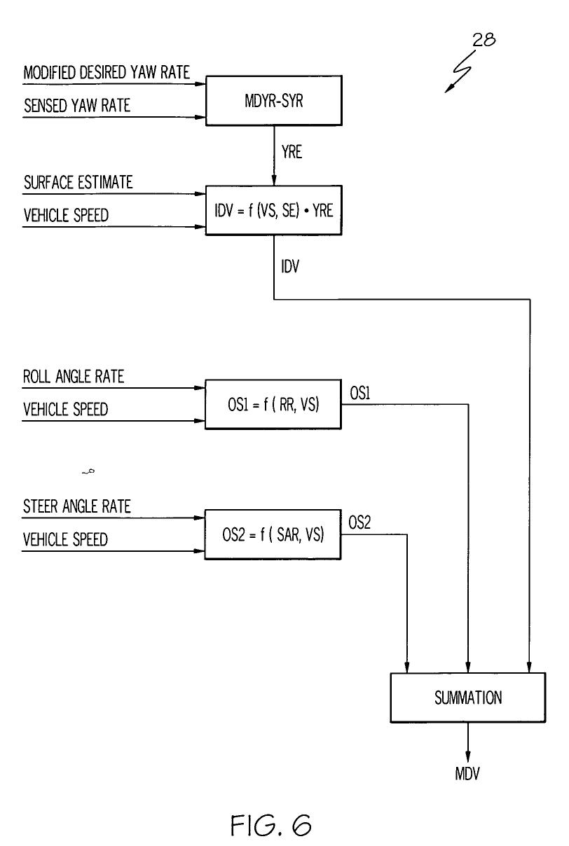

Referring to FIGS. 1 through 6, a first method of the invention is for providing stability control for a vehicle 10 having left and right wheels 12 & 14 and 16 & 18 and includes steps a) through c). Step a) is labeled as “Calculate Modified Desired Yaw Rate” in block 20 of FIG. 1. Step a) includes calculating a modified desired yaw rate (see FIG. 2) for the vehicle using steer angle, steer angle rate, steer transition state, steer transition time, vehicle speed, lateral acceleration, and estimated surface friction (called “Surface Estimate” in the figures). Step b) is labeled as “Calculate Modified Desired Speed Difference Between Left And Right Vehicle Wheels” in block 22 of FIG. 1. Step b) includes calculating a modified desired speed difference between the left and right wheels 12 & 14 and 16 & 18 (see FIGS. 2 and 6 wherein such modified desired speed difference is called “Modified Delta Velocity” or “MDV”) using the modified desired yaw rate, the steer angle rate, roll angle rate, the estimated surface friction, the vehicle speed, and sensed yaw rate. Step c) is labeled as “Apply Modified Desired Speed Difference To Wheels” in block 24 of FIG. 1. Step c) includes applying the modified desired speed difference to the left and right wheels 12 & 14 and 16 & 18 (see FIG. 2).

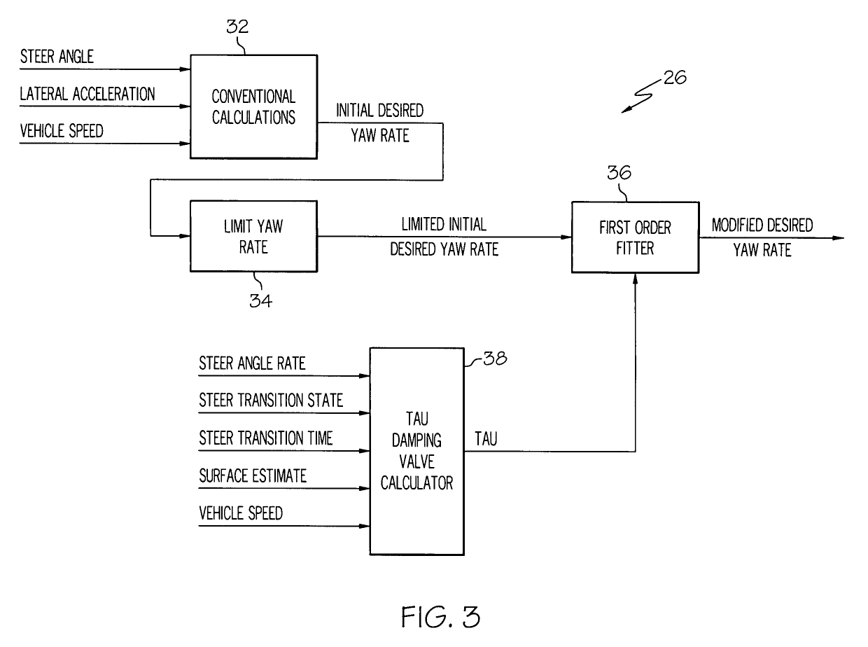

In one enablement of the first method, step a) uses a vehicle reference model 26 having steer angle, steer angle rate, steer transition state, steer transition time, vehicle speed, lateral acceleration, and estimated surface friction as inputs and having the modified desired yaw rate as an output (see FIGS. 2 and 3). In the same or a different enablement, step b) uses a vehicle control term calculator 28 having the modified desired yaw rate, the steer angle rate, roll angle rate, the estimated surface friction, the vehicle speed, and sensed yaw rate as inputs and having the modified desired speed difference between the left and right wheels 12 & 14 and 16 & 18 (also called “Modified Delta Velocity” and “MDV”) as an output (see FIGS. 2 and 6). In the same or a different enablement, step c) supplies the modified desired speed difference (“modified Delta Velocity” or “MDV”) to a brake system controller 30 adapted to apply brake signals to individually brake each of the left and right wheels 12 & 14 and 16 & 18 to achieve the modified desired speed difference (“Modified Delta Velocity” or “MDV”). In FIG. 2, the un-labeled arrowed lines from the brake system controller 30 to the wheels 12, 14, 16 and 18 schematically represent such brake signals. In one example, input signals are filtered as appropriate to reduce noise.

Steer transition state is a count of the number of times the driver reverses steering direction for a predetermined minimum steer angle reversal and a predetermined minimum steer angle reversal rate. Steer transition time is the time in one steer transition state. In one example, estimated surface friction (called “Surface Estimate” in the figures) has a value of 0.1 for a dry surface and 1.0 for ice. The remaining inputs (e.g., angles, rates, speed and acceleration) are obtainable by those skilled in the art from a suitably instrumented vehicle.

In a first employment of the first method, step a) includes calculating an initial desired yaw rate using the steer angle, the lateral acceleration, and the vehicle speed as is conventionally done in calculating a conventional desired yaw rate, such as by using conventional calculations (represented by block 32 of FIG. 3).

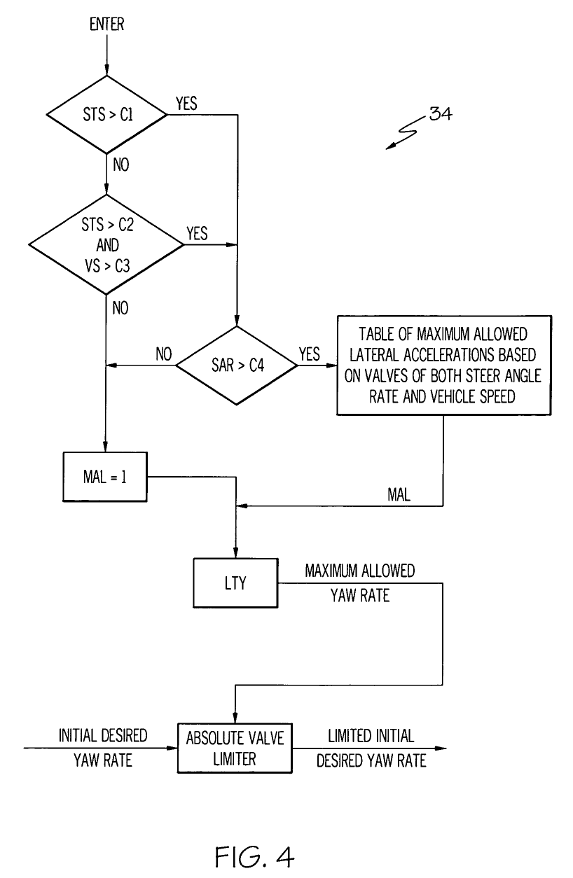

In one variation, step a) includes limiting the initial desired yaw rate based at least on the steer rate, such limiting of the initial desired yaw rate being represented by block 34 in FIG. 3 and shown in greater detail in FIG. 4. In FIG. 4 (and in all other figures), C1, C2, etc. represent predetermined constants which are obtained from previous vehicle testing and/or vehicle computer simulations for vehicle stability control as is within the ordinary level of skill of the artisan. The absolute value of the initial desired yaw rate is limited. The box labeled “Table Of Maximum Allowed Lateral Accelerations Based on Values Of Both Steer Angle Rate And Vehicle Speed” represents a table of values obtained from previous vehicle testing and/or vehicle computer simulations for vehicle stability control as is within the ordinary level of skill of the artisan. The box labeled “Convert To Maximum Allowed Yaw” represents a conversion that is within the ordinary level of skill of the artisan.

In FIG. 4, STS is steer transition rate, VS is vehicle speed, SAR is steer angle rate, MAL is maximum allowed lateral acceleration, and LTY is Lateral acceleration To Yaw rate conversion (such conversion being within the ordinary level of skill of the artisan). It is noted that C2 is less than C1.

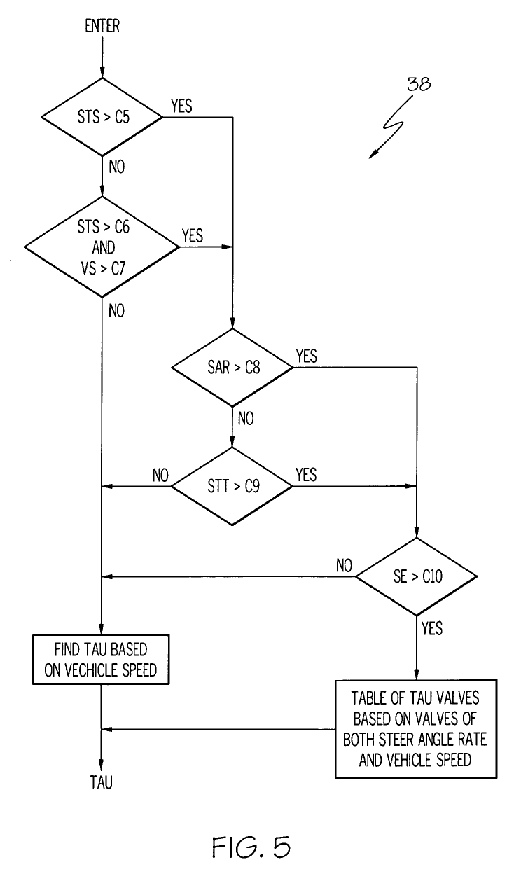

In one modification, step a) includes calculating a tau damping value of a first order filter 36 using the steer angle rate, the steer transition state, the steer transition time, the estimated surface friction, and the vehicle speed, such as by using a tau damping value calculator (represented by block 38 in FIG. 3 and shown in greater detail in FIG. 5). In FIG. 5, the block labeled “Find Tau Based On Vehicle Speed” represents conventional calculations used for a first order filter for conventionally filtering a conventional desired yaw rate. The box labeled “Table Of Tau Values Based on Values Of Both Steer Angle Rate And Vehicle Speed” represents a table of tau values obtained from previous vehicle testing and/or vehicle computer simulations for vehicle stability control as is within the ordinary level of skill of the artisan.

In FIG. 5, STS is steer transition rate, VS is vehicle speed, SAR is steer angle rate, STT is steer transition time, and SE is surface estimate. It is noted that C6 is less than C5.

In one illustration, step a) includes calculating the modified desired yaw rate by filtering the limited initial desired yaw rate using a first order filter 36 having the calculated tau damping value (see FIG. 3).

In the same or a different employment of the first method, and referring to FIG. 6, step b) includes calculating a yaw rate error equal to the modified desired yaw rate minus the sensed yaw rate and includes calculating an initial desired speed difference between the left and right wheels equal to the calculated yaw rate error times a function of the estimated surface friction and the vehicle speed. Such yaw rate error and initial desired speed difference calculation is conventionally done in calculating a conventional desired yaw rate and a conventional desired speed difference. In one example, the function is expressed as a table.

In FIG. 6, YRD is modified desired yaw rate, SYR is sensed yaw rate, YRE is yaw rate error, IDV is initial delta velocity which is initial desired speed difference between the left and right vehicle wheels, VS is vehicle speed, SE is surface estimate (estimated surface friction), MDV is modified delta velocity which is modified desired speed difference between the left and right vehicle wheels, RR is roll rate, SAR is steer angle rate, OS1 is a first offset to IDV, and OS2 is a second offset to IDV.

In one application, referring to FIG. 6, step b) includes calculating the modified desired speed difference as equal to the initial desired speed difference plus a first offset which is a function of the roll angle rate and the vehicle speed plus a second offset which is a function of the steer angle rate and the vehicle speed. In one example, the functions are expressed as tables whose values have been obtained from previous vehicle testing and/or vehicle computer simulations for vehicle stability control as is within the ordinary level of skill of the artisan.

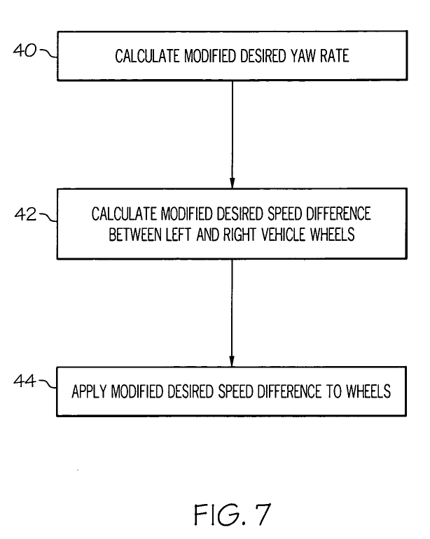

Referring to FIG. 7 and the vehicle 10 of FIG. 2, a second method of the invention is for providing stability control for a vehicle 10 having left and right wheels 12 & 14 and 16 & 18. The second method includes steps a) through c). Step a) is labeled as “Calculate Modified Desired Yaw Rate” in block 40 of FIG. 7. Step a) includes calculating a modified desired yaw rate for the vehicle using steer angle, steer angle rate, steer transition state, steer transition time, vehicle speed, lateral acceleration, and estimated surface friction. Step b) is labeled as “Calculate Initial Desired Speed Difference Between Left And Right Vehicle Wheels” in block 42 of FIG. 7. Step b) includes calculating an initial desired speed difference between the left and right wheels using the modified desired yaw rate, the estimated surface friction, the vehicle speed, and sensed yaw rate. Step c) is labeled as “Apply Initial Desired Speed Difference To Wheels” in block 44 of FIG. 7. Step c) includes applying the initial desired speed difference to the left and right wheels.

The employment, modification, etc. of step a) in the first method are equally applicable to step a) in the second method.

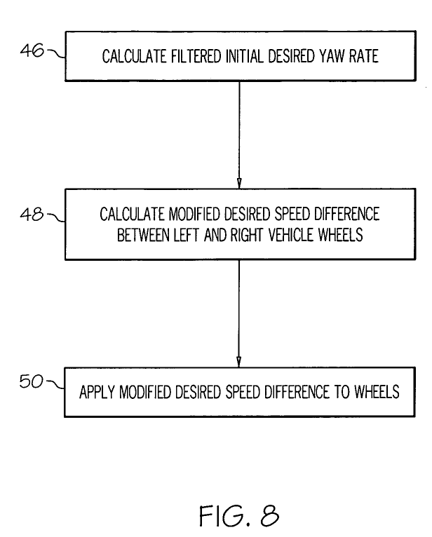

Referring to FIG. 8 and the vehicle 10 of FIG. 2, a third method of the invention is for providing stability control for a vehicle 10 having left and right wheels 12 & 14 and 16 & 18. The third method includes steps a) through c). Step a) is labeled as “Calculate Filtered Initial Desired Yaw Rate” in block 46 of FIG. 8. Step a) includes calculating a filtered initial desired yaw rate for the vehicle 10 using steer angle, vehicle speed, and lateral acceleration. Step b) is labeled as “Calculate Modified Desired Speed Difference Between Left And Right Vehicle Wheels” in block 48 of FIG. 8. Step b) includes calculating a modified desired speed difference between the left and right wheels 12 & 14 and 16 & 18 using the filtered initial desired yaw rate, the steer angle rate, roll angle rate, the estimated surface friction, the vehicle speed, and sensed yaw rate. Step c) is labeled as “Apply Modified Desired Speed Difference To Wheels” in block 50 of FIG. 8. Step c) includes applying the modified desired speed difference to the left and right wheels 12 & 14 and 16 & 18.

The employment and application of step b) and the employment of step a) in the first method are equally applicable to step b) and step a) in the third method. In one utilization of the third method, step a) includes filtering the initial desired yaw rate using a first order filter having a tau damping value based on vehicle speed.

Several benefits and advantages are derived from one or more of the methods of the invention. In one example, after certain steering reversals by the driver with high steering angle rates, the initial desired yaw rate is limited for some time after the event to reduce the yaw rate overshoot. In the same or a different example, during certain maneuvers involving high steer angle rates, damping of the desired yaw rate is increased to slow the response of the vehicle control to inputs from the driver for increased vehicle stability. In the same or a different example, during certain maneuvers involving high roll angle rates and high steer angle rates, the vehicle control term (i.e., the desired speed difference) is offset by a function of the roll angle rate and the vehicle speed and is offset by a function of the steer angle rate and the vehicle speed for increased vehicle stability.

The foregoing description of several methods of the invention has been presented for purposes of illustration. It is not intended to be exhaustive or to limit the invention to the precise steps disclosed, and obviously many modifications and variations are possible in light of the above teaching. It is intended that the scope of the invention be defined by the claims appended hereto.

1. A method for providing stability control for a vehicle having left and right wheels comprising:
a) calculating a modified desired yaw rate for the vehicle using steer angle, steer angle rate, steer transition state, steer transition time, vehicle speed, lateral acceleration, and estimated surface friction;
b) calculating a modified desired speed difference between the left and right wheels using the modified desired yaw rate, the steer angle rate, roll angle rate, the estimated surface friction, the vehicle speed, and sensed yaw rate; and
c) applying the modified desired speed difference to the left and right wheels.

2. The method of claim 1, wherein step a) includes calculating an initial desired yaw rate using the steer angle, the lateral acceleration, and the vehicle speed.

3. The method of claim 2, wherein step a) includes limiting the initial desired yaw rate based at least on the steer rate.

4. The method of claim 3, wherein step a) includes calculating a tau damping value of a first order filter using the steer angle rate, the steer transition state, the steer transition time, the estimated surface friction, and the vehicle speed.

5. The method of claim 4, wherein step a) includes calculating the modified desired yaw rate by filtering the limited initial desired yaw rate using a first order filter having the calculated tau damping valve.

6. The method of claim 5, wherein step b) includes calculating a yaw rate error equal to the modified desired yaw rate minus the sensed yaw rate and calculating an initial desired speed difference between the left and right wheels equal to the calculated yaw rate error times a function of the estimated surface friction and the vehicle speed.

7. The method of claim 6, wherein step b) includes calculating the modified desired speed difference as equal to the initial desired speed difference plus a function of the roll angle rate and the vehicle speed plus a function of the steer angle rate and the vehicle speed.

8. The method of claim 1, wherein step b) includes calculating a yaw rate error equal to the modified desired yaw rate minus the sensed yaw rate and calculating an initial desired speed difference between the left and right wheels equal to the calculated yaw rate error times a function of the estimated surface friction and the vehicle speed.

9. The method of claim 8, wherein step b) includes calculating the modified desired speed difference as equal to the initial desired speed difference plus a function of the roll angle rate and the vehicle speed plus a function of the steer angle rate and the vehicle speed.

10. A method for providing stability control for a vehicle having left and right wheels comprising:
a) calculating a modified desired yaw rate for the vehicle using steer angle, steer angle rate, steer transition state, steer transition time, vehicle speed, lateral acceleration, and estimated surface friction;
b) calculating an initial desired speed difference between the left and right wheels using the modified desired yaw rate, the estimated surface friction, the vehicle speed, and sensed yaw rate; and
c) applying the initial desired speed difference to the left and right wheels.

11. The method of claim 10, wherein step a) includes calculating an initial desired yaw rate using the steer angle, the lateral acceleration, and the vehicle speed.

12. The method of claim 11, wherein step a) includes limiting the initial desired yaw rate based at least on the steer rate.

13. The method of claim 12, wherein step a) includes calculating a tau damping value of a first order filter using the steer angle rate, the steer transition state, the steer transition time, the estimated surface friction, and the vehicle speed.

14. The method of claim 13, wherein step a) includes calculating the modified desired yaw rate by filtering the limited initial desired yaw rate using a first order filter having the calculated tau damping valve.

15. A method for providing stability control for a vehicle having left and right wheels comprising:
a) calculating a filtered initial desired yaw rate for the vehicle using steer angle, vehicle speed, and lateral acceleration;
b) calculating a modified desired speed difference between the left and right wheels using the filtered initial desired yaw rate, the steer angle rate, roll angle rate, the estimated surface friction, the vehicle speed, and sensed yaw rate; and
c) applying the modified desired speed difference to the left and right wheels.

16. The method of claim 15, wherein step b) includes calculating a yaw rate error equal to the modified desired yaw rate minus the sensed yaw rate and calculating an initial desired speed difference between the left and right wheels equal to the calculated yaw rate error times a function of the estimated surface friction and the vehicle speed.

17. The method of claim 16, wherein step b) includes calculating the modified desired speed difference as equal to the initial desired speed difference plus a function of the roll angle rate and the vehicle speed plus a function of the steer angle rate and the vehicle speed.

18. The method of claim 17, wherein step a) includes calculating an initial desired yaw rate using the steer angle, the lateral acceleration, and the vehicle speed.

19. The method of claim 18, wherein step a) includes filtering the initial desired yaw rate using a first order filter having a tau damping value based on vehicle speed.

20. The method of claim 15, wherein step a) includes filtering the initial desired yaw rate using a first order filter having a tau damping value based on vehicle speed.
